(19) United States
(12) Patent Application Publication
(10) Pub. No.: US 2006/0226786 A1
(43) Pub. Date: Oct. 12, 2006

(54) Inductively-coupled plasma etch apparatus and feedback control method thereof

(76) Inventors: Chaung Lin, Hsinchu (TW); Ken-Chyang Leou, Hsinchu (TW); Cheng-Hung Chang, Hsinchu (TW); Kai-Mu Hsiao, Hsinchu (TW)

Correspondence Address: J.C. Patents, Inc.;Suite 250, 4 Venture, Irvine, CA, 92618, US

(21) Appl. No.: 11/260,011

(22) Filed: Oct. 26, 2005

(30) Foreign Application Priority Data
Apr. 12, 2005 (TW) 94111444

(51) Int. Cl. H01J 7/24

(52) U.S. Cl. 315/111.21

(57) ABSTRACT

An inductively-coupled plasma etch apparatus and a feedback control method thereof are provided. A voltage/current measuring device is connected to an electrostatic chuck of the plasma etching apparatus, so as to measure the RF current, voltage and the phase angle between them on the electrostatic chuck. The ion current and the RF bias voltage are obtained by calculation of the RF current, voltage and the phase angle. Finally, using the obtained ion current and the RF bias voltage to feedback control the RF power generator in order to achieve the desired plasma status.

### CROSS-REFERENCE TO RELATED APPLICATION

This application claims the priority benefit of Taiwan application serial no. 94111444, filed on Apr. 12, 2005. All disclosure of the Taiwan application is incorporated herein by reference.

### BACKGROUND OF THE INVENTION

1. Field of Invention

The present invention relates to a plasma etch apparatus and a feedback control method thereof. More particularly, the present invention relates to a plasma etch apparatus and a feedback control method thereof with feedback controlled ion current and RF bias voltage.

2. Description of Related Art

Among the integrated circuit manufacturing apparatuses, the cost of plasma manufacturing apparatus is about 30%-40% of the overall cost; and most of them are apparatuses with high unit price (the unit price may be over NTD 100,000,000). The apparatuses include plasma etching apparatus, plasma chemical gas depositing apparatus, plasma physical gas depositing apparatus, light resistance removing apparatus, surface treatment apparatus and other relative apparatuses. Wherein, the most complicated one is the physical and chemical mechanisms related in the plasma etching apparatus. During the etching process, the creation of the etching residues makes the plasma environment changed dynamically along the space position (because of the chemical reaction of different etching pattern on the surface of electrostatic chuck with the surface of the internal wall). Accordingly, the plasma etching apparatus in the age of nanometer technology is required having the ability of real-time process specification measurement, real-time feedback control and device property (i.e. uniformity) adjustment.

In the aspect of process specification real-time measurement, the current development trend emphasizes on the measurement of the physical/chemical properties (such as weight, power, density and the change along time, space thereof) of atom, molecule, ion, and etching residues in the reaction of the surface materials of process cavity and electrostatic chuck. On one hand, the measured result can be used as reference for analyzing the process specification; and on the other hand, the measured result can be used as the signal source of the detector for controlling the feedback process. Since the controlling parameters are physical/chemical parameters (such as gas flow volume, rate of input gas, temperature, gas pressure or power of plasma, etc.) of etching reaction, which is more direct and more effective than the current apparatus, the uniformity and stability of the process can be more precisely and effectively controlled.

Nowadays, most of the process devices monitor the important process parameters, routine testing, routine device maintenance by Statistical Process Control (SPC) to improve the process stability and productivity. However, the current monitor system does not provide a warning function to prevent the manufacturing yield from damages until during the steps of device testing or subsequent wafer checking and measuring. The problem can be only found until then. Thus, when the problem occurs, thousands of wasted wafers need to be thrown away that will severely impact the operational cost and product delivery.

According to the research reports of Semiconductor Industry Association (SIA) and SEMATECH, the aforementioned loss due to the lack of the warning system can be overcome by applying the Advanced Process Control (APC) with the In-Situ detector and Advanced Equipment Control (AEC).

Wherein, APC can roughly be divided into two types: Model-Based Process Control (MBPC) and Fault Detection and Classification (FDC).

The earlier developed FDC technology utilized the measured data of the In-Situ detector, i.e., in-situ forecasting the device failure, to find out the reason of the abnormal status via failure sorting technology. MBPC was developed in the mid 1990s, emphasizing on integrating equipment on-line, operational parameters, status parameters, wafer quality measurement variations etc. Through control of the computation of the forecast estimation, the operational parameters can be adjusted via on-line feedback.

According to the revising speed of the operation parameters, MBPC can also be divided into “Run-to-Run Control” and “Real-time feedback control (Real-Time Control)”. Run-to-Run Control measures process status by in-situ detector; next, calculate the process model by continuous measuring data; then forecast the next result via the in-situ detector in the manufacturing process and compensate the system loss of pass rate by revising the operation parameters (or component rate) in advance, so that to improve the process result to meet the expectation. However, the trend of the current device design prefers single wafer process (Single Wafer Process), a stricter requirement for the device and process control is required. Dynamically adjusting the operation parameters by in-situ feedback control in each wafer process, the process status detected by the detector can remain good repeatability to meet actual requirement.

Since the plasma status in the reaction chamber will influence the plasma process reaction directly, therefore, plasma with stability and predefined status can assure the quality. However, as each plasma apparatus has different structure, such as the different resistance match wire, even the RF power generators export the same power, the power inputting into the plasma cavity may be still different that consequently the plasma status is different.

However, all the current plasma apparatus has no such function of plasma parameters feedback controls. Therefore, when the reaction chamber in the plasma apparatus is interfered by the outside environment or the internal walls of the cavity have changed, there is no way to real-time adjust the output of the RF power generators to meet the predefined plasma status according to the actual plasma status in reaction chamber. As a result, the quality of the wafer is influenced.

Only U.S. Pat. No. 6,727,655B2 discloses a method and apparatus to monitor electrical states at a workpiece in a semiconductor processing chamber. The method connects an RF generator with a sensor located between the electrodes at the bottom of the reaction chamber, ascertaining an impedance of the signal path, sensing electrical characteristics of the RF power at the RF signal source and obtaining values of the electrical states at the workpiece. However, since there is only one RF power generator, the two plasma parameters of ion current and RF bias voltage in the reaction chamber can not be controlled simultaneously.

### SUMMARY OF THE INVENTION

Accordingly, the present invention is directed to provide an inductively-coupled plasma etch apparatus, which uses the obtained ion current and RF bias voltage to feedback control the RF bias voltage power generator in order to achieve the desired plasma.

Another object of the present invention is to provide a feedback control method of inductively-coupled plasma, which uses the obtained ion current and RF bias voltage to feedback control the RF power generators in order to achieve the desired plasma.

In the plasma etching process, ion concentration, ion energy and reactive particle concentration are the key factors which affect the ion reaction. The effect of the two former factors is particularly important in the state with high reactive particle concentration.

Therefore, in the present invention, a voltage/current measuring device is connected to an electrostatic chuck of the plasma etching apparatus, so as to measure the RF current, voltage and the phase angle between them on the electrostatic chuck. The ion current and RF bias voltage are obtained by some calculations of the RF current, voltage and the phase. The two measured values are related to ion density and ion energy. Finally, use the obtained ion current and RF bias voltage to feedback control the RF power generators in order to control the output of the RF power generators.

The present invention provides an inductively-coupled plasma etch apparatus and a feedback control method thereof. The apparatus includes a reaction chamber, an induction coil, an electrostatic chuck, a voltage/current measuring device and a controller.

The induction coil is configured within the reaction chamber, and a first bias voltage of the induction coil is provided via a plasma power generator. A first matching network is configured between the induction coil and the plasma power generator.

The electrostatic chuck is disposed at the bottom of the reaction chamber to support a wafer. And, the electrostatic chuck is connected to an RF bias voltage power generator so to provide a second bias voltage of the wafer. The electric field generated by the voltage difference between the first and the second bias voltages makes a reaction gas through the reaction chamber generate plasma to etch the wafer.

The voltage/current measuring device is connected to the position between the electrostatic chuck and the RF bias voltage generator, so as to measure an RF current, an RF voltage, and the phase angle between them on the electrostatic chuck. And, a second matching network is disposed between the voltage/current measuring device and the RF bias voltage generator. The RF signal on the electrostatic chuck can be obtained after calculation of the transmission cable compensation, and the RF signal includes RF bias voltage. Then, the ion current can be obtained by the calculation of Power/Voltage formula. In such, we can obtain one ion current measuring data and one RF voltage measuring data.

Finally, the controller receives the measured data of RF bias voltage and ion current; calculate the difference between the measured data and the predefined data of ion current to generate a first control signal; calculate the difference between the measured data and the predefined data of RF bias voltage to generate a second control signal. The first and second control signal feedback control the plasma power generator and the RF bias voltage power generator, respectively.

Accordingly, the inductively-coupled plasma etch apparatus will no longer be affected by the changes of the reaction chamber due to the interference of outside environment and the condition changes of the inner walls of the cavity, so as to prevent the random change of the outside environment and the difference of the device configuration which affect the etching quality.

Moreover, the present invention also provides a feedback control method of plasma etching process for the above inductively-coupled plasma etch apparatus, including:

Firstly, measure the RF current, voltage and the phase angle between them on the electrostatic chuck to obtain an RF current measured data and an ion current measured data.

Next, calculate the difference between the measured data and the predefined data of ion current to generate a first control signal; and calculate the difference between the measured data and the predefined data of RF bias voltage to generate a second control signal.

Finally, the first and second control signals are used to feedback control the plasma power generator and the RF bias voltage power generator, respectively.

The present invention also provides a feedback control method of a plasma etching process for an inductively-coupled plasma etch apparatus. The characteristics are as follows. In the plasma etching process, the method controls the plasma status within the reaction chamber of the inductively-coupled plasma etch apparatus by controlling the ion energy and ion density when the plasma impacts the surface of a wafer in a reaction chamber.

The aforementioned method controls the energy and density of the ions impacting the surface of wafer by measuring the RF current, voltage and the phase angle between them on the electrostatic chuck. The ion current and RF bias voltage are obtained by calculation of the RF current, voltage and the phase angle. Then, the measured RF bias voltage and measured ion current are adjusted to be nearer to the predefined RF bias voltage and the predefined ion current, so to achieve the desired plasma status.

And, the method of measuring the RF current, voltage and the phase angle between them is: transmitting the signals related to the RF current, voltage and the phase angle via a transmission line with a predefined length and resistance, and the signals are measured by a voltage/current measuring device.

As voltage/current measuring device of the inductively-coupled plasma etch apparatus of the present invention can apply to a commercial RF ohmmeter to directly measure the ion current and RF voltage, no lengthy and laborious R&D is required. Therefore, the current problem that can not be immediately feedback controlled can be improved. The interference due to differences of device configurations and changes of the outside environment can be removed so as to improve the stability of the quality of the etching process.

The above and other features of the present invention will be better understood from the following detailed description of the preferred embodiments of the invention that is provided in communication with the accompanying drawings.

### BRIEF DESCRIPTION OF THE DRAWINGS

FIG. 1 is a system schematic block diagram of an inductively-coupled plasma etch apparatus of the present invention.

FIG. 2 is a flowchart of a feedback control method for plasma etching process of the present invention.

FIGS. 3(a) to 3(d) show the dynamic response of the close-loop and open-loop design control under a fully operational condition.

FIGS. 4(a) to 4(d) show the dynamic response of the close-loop and open-loop design control in plasma temporary condition.

FIGS. 5(a) to 5(d) show the dynamic response of the close-loop and open-loop design control with pressure disturbance.

Table 1 is the design experiment of two elements with 10 m Torr.

Table 2 is the etching rate under the control of open-loop in plasma temporary condition.

Table 3 is the etching rate under the control of open-loop with slight interference of pressure.

Table 4 is the design experiment of two elements with 12 m Torr.

### DESCRIPTION OF EMBODIMENTS

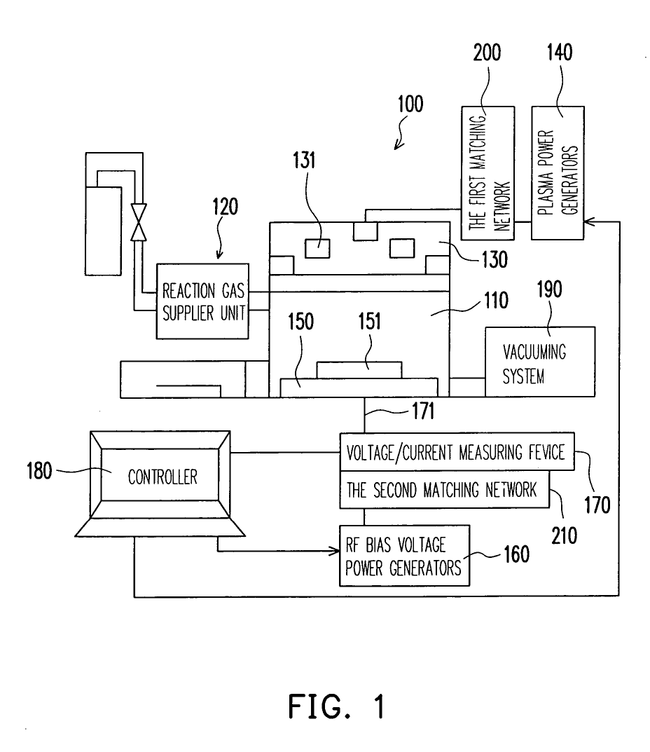

Please refer to FIG. 1 which is a system schematic block diagram of an inductively-coupled plasma etch apparatus of the present invention. The present invention measures the RF current, the RF voltage and the phase angle between them of the electrostatic chuck 150 in real operation within a reaction chamber 110 of etching device by a voltage/current measuring device 170, so as to obtain an ion current measured data and an RF voltage measured data. And the controller 180 generates a first control signal by calculation of the difference between the measured ion current and the preferred ion current; and generates a second control signal by calculation of the difference between the measured RF voltage and the preferred RF voltage. Then, the first control signal and the second control signal feedback control the plasma power generator 140 and RF bias voltage power generator 160, so to achieve desired plasma in the reaction chamber 110.

The inductively-coupled plasma etch apparatus 100 includes: a reaction chamber 110, a gas provider unit 120, a top cover 130, an induction coil 131, a plasma power generator 140, an electrostatic chuck 150, a wafer 151, a second RF signal generator 160, a voltage/current measuring device 170, a controller 180 and a vacuuming system 190.

The gas provider unit 120 is connected to the reaction chamber 110, and provides gas to the reaction chamber 110.

The top cover 130 is disposed on the upper end of the reaction chamber 110, and tightly attached to the reaction chamber 110. An induction coil 131 is provided within the top cover 130, and is provided a first bias voltage by a plasma power generator 140. And, the plasma power generator 140 can be a 13.56M RF power generator. A first matching network 200 can be configured between the plasma power generator 140 and the induction coil 131 in order to obtain the desired RF power transmission and also protect the plasma power generator 140.

The electrostatic chuck 150 is disposed at the bottom of the reaction chamber 110 to support a wafer 151 for etching. The chuck 150 may be an electrostatic chuck, mainly including a support seat to support wafer 151, a DC power supplier to provide a force which makes the wafer 151 stable on the electrostatic chuck 150, a helium pressure controller with cooling system, a flux reader, etc.

The electrostatic chuck 150 is connected to an RF bias voltage power generator 160 to provide the wafer 151 a second bias voltage. The RF bias voltage power generator 160 may be a 13.56M RF power generator. Also, a second matching network 210 is configured between the electrostatic chuck 150 and the RF bias voltage power generator 160 in order to obtain desired RF power transmission. Furthermore, the design also protects the RF bias voltage power generator 160.

When it is ready to perform the plasma etching, the reaction chamber 110 will be in vacuum condition by the vacuuming system 190. Then an electric field is formed within the reaction chamber 110 by the voltage difference between the first bias voltage and the second bias voltage so that the gas through the reaction chamber 110 will generate plasma. Therefore, the chemical reaction between the electriferous ion generated by plasma and neutral free radical ion can etch the portion of the wafer 151 which is not protected by the etching mask.

The characteristic of the present invention is to measure ion current and RF bias voltage of the electrostatic chuck 150. As the volume of the ion current and the RF bias voltage is related to the number of the ions impacting the electrostatic chuck 150, therefore, the speed of etching reaction can be controlled completely by measuring the two parameters. In addition, by calculation of the controller 180 the RF power generator 140 and RF bias voltage power generator 160 can be feedback controlled.

In the present invention, a voltage/current measuring device 170 is provided between the electrostatic chuck 150 and the second matching network 210 in order to measure the current, the RF voltage and the phase angle between them. If the voltage/current measuring device 170 is connected directly to the bottom of the electrostatic chuck 150, when the phase angle of the RF signal approaches to 90° it will be difficult for the measurement. Therefore, in the present invention, the voltage/current measuring device 170 is connected to the bottom of the electrostatic chuck 150 by a low power consumption coaxial transmission cable 171. The original difference of the phase angles can be enlarged via the transmission cable 171 with the predefined length and predefined resistance, so that the measured result is more accurate. Further, the original difference of phase angles can be reverse-calculated. The RF signals on the wafer 150 can be obtained after the calculation of the compensation of the transmission cable, and, the RF signal includes RF bias voltage. Next, the ion current can be obtained by the calculation of the Power/Voltage Equation, so as to obtain one ion current measured data and one RF voltage measured data. The voltage/current measuring device 170 may be an RF ohmmeter.

The controller 180 receives the measured data of ion current and RF bias voltage and calculate the difference between the measured data and the predefined data of ion current to generate a first control signal; and calculate the difference between the measured data and the predefined data of RF bias voltage to generate a second control signal. The first and second control signals feedback control the plasma power generator 140 and the RF bias voltage power generator 160, respectively, in order to change the output power of the plasma power generator 140 and the RF bias voltage power generator 160. In such, the two parameters of ion current and RF bias voltage can be controlled at the same time. Accordingly, the number and energy of the ion impacting the electrostatic chuck 150 can be controlled so as the etching reaction speed is entirely monitored.

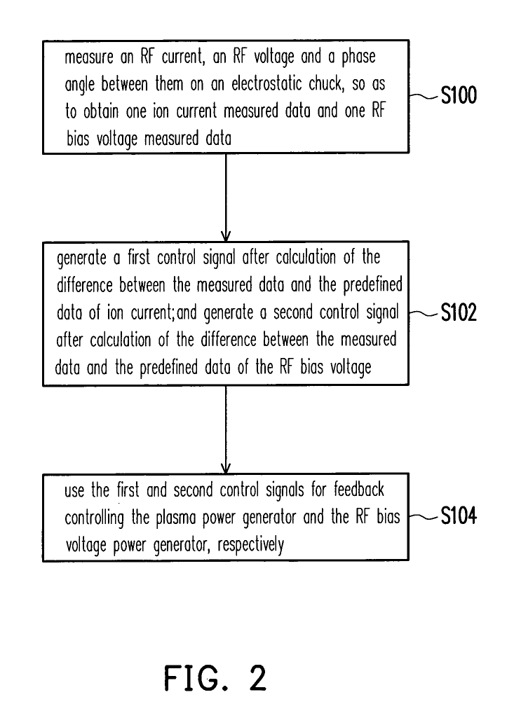

Please refer to FIG. 2. FIG. 2 is a flowchart of a feedback control method for plasma etching process of the present invention. The feedback control method is applied to the inductively-coupled plasma etch apparatus as shown in FIG. 1. The architecture can be referred to FIG. 1 for details, and is not repeated here.

Firstly, measure an RF current, an RF voltage and a phase angle between them on an electrostatic chuck, so as to obtain one ion current measured data and one RF bias voltage measured data (S100). Measure the RF current, RF voltage and a phase angle between them of the electrostatic chuck 150 by the voltage/current measuring device 170 below the electrostatic chuck 150. The RF signals on the wafer 150 can be obtained after calculation of the compensation of the transmission cable; and the RF signal includes RF bias voltage. Next, the ion current can be obtained by the Power/Voltage Equation, so as to obtain one ion current measured data and one RF voltage measured data.

Then, generate a first control signal after calculation of the difference between the measured data and the predefined data of ion current; and generate a second control signal after calculation of the difference between the measured data and the predefined data of the RF bias voltage (S102). The measured data of ion current and the RF bias voltage by the voltage/current measuring device 170 will be transmitted to the controller 180. Next, generate a first control signal after the calculation of the difference between the measured data and the predefined data of ion current by the controller 180; and generate a second control signal after the calculation of the difference between the measured data and the predefined data of RF bias voltage by the controller 180.

Finally, use the first and second control signals for feedback controlling the plasma power generator and the RF bias voltage power generator, respectively (S104). The first control signal and the second control signal generated after the calculation of the controller 180 may feedback control the plasma power generator 140 and the RF bias voltage power generator 160 so to change the RF output power. As a result, the desired plasma in the reaction chamber 110 can be achieved.

To verify the feasibility of the present invention, the present invention utilizes the system architecture as shown in FIG. 1, combining the two proportional-integral (PI) controllers of Ziegler-Nichols tuning method, as the controller 180. In addition, two 13.56 MHz RF power generators are used as the plasma power generator 140 and the RF bias voltage power generator 160 as the actuator portion of the control circuit to drive the induction coil 131 and the electrostatic chuck 150.

(The whole paragraph is missing.) The signals measured by the RF ohmmeter will be first performed with compensated calculation by transmission line theory to eliminate the effect due to coaxial transmission cable. Next, obtain the ion current using the Power/Voltage method to divide the measured RF power by the major RF bias voltage. Though the obtained ion current may not actually reflect the absolute ion current data, the aforementioned calculation can be used as a controlled variation after adjustment. Other controlled variables are the RMS RF voltage; the RMS RF voltage is proportional to the sheath voltage and the ion energy.

In the aspect of the design of the controller, firstly generate the dynamic model of plasma which applies one rank conversion function. Then, change the input of the plasma power (ICP Power) and the RF bias voltage power (Bias Power). Next, measure the corresponding changes of the ion current and the RF voltage. The obtained dynamic mode is as shown in Formula 1:

$$[ \begin{matrix}ion current ( mA ) \\ rf voltage ( V )\end{matrix} ] = ( \begin{matrix}\frac{1}{0.316 s + 1} & 0 \\ \frac{- 0.096}{0.317 s + 1} & \frac{0.29}{1.26 s + 1}\end{matrix} ) [ \begin{matrix}ICP power ( W ) \\ bias power ( W )\end{matrix} ] \qquad ( 1 )$$

As the change of ion current due to the bias voltage power is very small, it can be omitted.

To simplify the process of calculation, consider the secondary system of RF voltage-bias voltage power as a Single-Input Single-Output system (SISO) and the effect due to the change of plasma power as an interference. The two SISO systems utilize PI controller of the Ziegler-Nichols tuning method for regulation. Comparing to the controller of a more complicated control theory, the effect and required calculation of the controller design can be reduced. The controller to regulate the ion current is as shown in Formula 2:

$${D}_{1} ( s ) = \frac{s + 1}{4 s} \qquad ( 2 )$$

And, the controller to regulate the ion current is as shown in Formula 3:

$${D}_{2} ( s ) = \frac{5 ( s + 1 )}{3 s} \qquad ( 3 )$$

The disperse type of the control conversion function can be obtained by bilinear approximation, that is, the relation formula as shown in Formula 4 substitutes the ‘s’ in Formulas 2 and 3, and the sampling period is 0.5 second. The dispersion conversion functions are as shown in Formula 5 and Formula 6, respectively:

$$\begin{matrix}s = ( \frac{2}{{T}_{s}} ) \frac{( z - 1 )}{( z + 1 )} & ( 4 ) \\ {D}_{1} ( z ) = \frac{0.3125 z - 0.1875}{z - 1} & ( 5 ) \\ {D}_{2} ( z ) = \frac{2.083 z - 1.25}{z - 1} & ( 6 )\end{matrix}$$

In such, the control system is applied to the controller 180 to feedback control the ion current and the RF bias voltage.

The etching experiment undergoing deposits a layer of 300 angstrom selenium dioxide and a layer of 9000 angstrom polycrystalline silicon on a six inch in diameter wafer, respectively, and the etching period is 60 seconds. And, the thicknesses of the films at nine different positions are measured by spectro-reflectometry and the thickness of the wafer is the averaged value of the nine measured points. And, the etching rate can be obtained by the averaged thicknesses before and after the etching process.

First, the controlled variable's responses are discussed. Four wafers are disposed within the reaction chamber 110 for etching. The operational condition of the open-loop control is 800 W plasma power and 150 W bias voltage power; while for the close-loop control system, the ion current is set as 760 mA and the RF bias voltage is set as 103V. No matter in open-loop control system or close-loop control system, the pressure in reaction chamber 110 is 10 mTorr and the flow rate is 95/5 sccm. We obtain three samples in the open-loop control system and the close-loop control system, respectively.

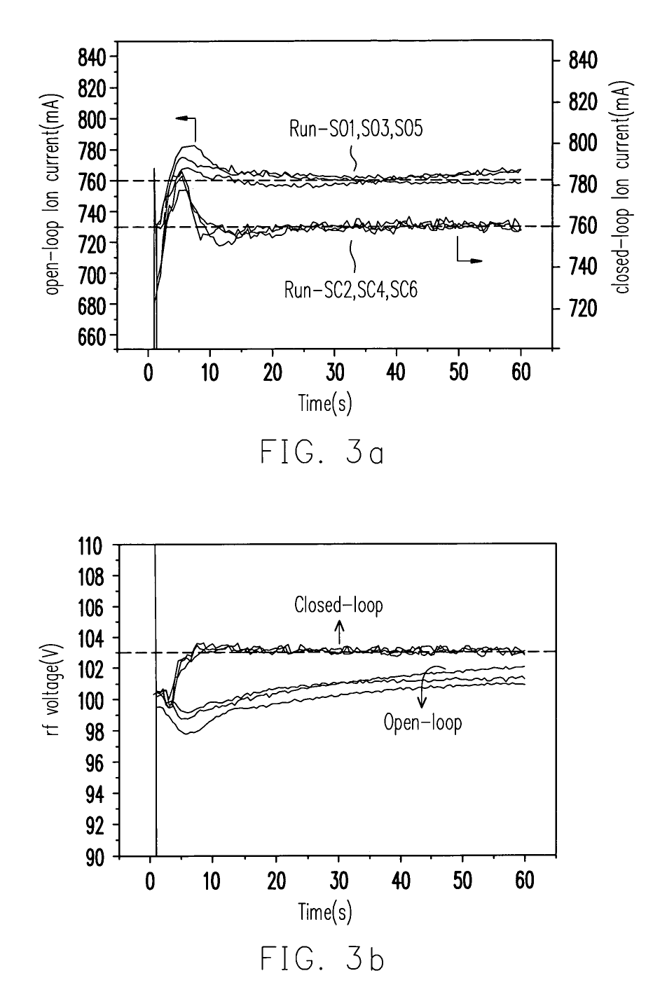

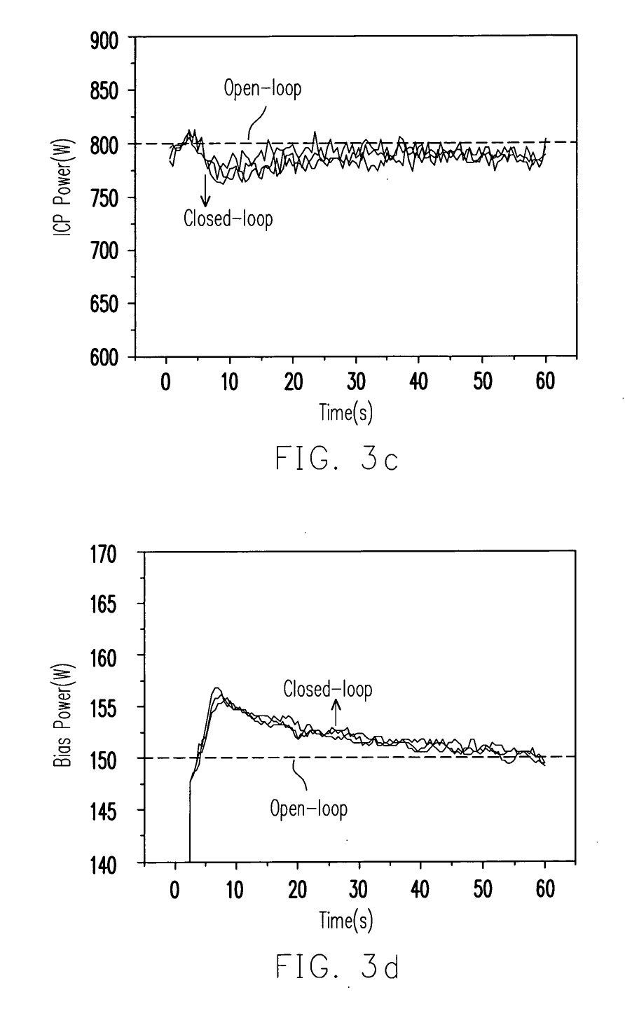

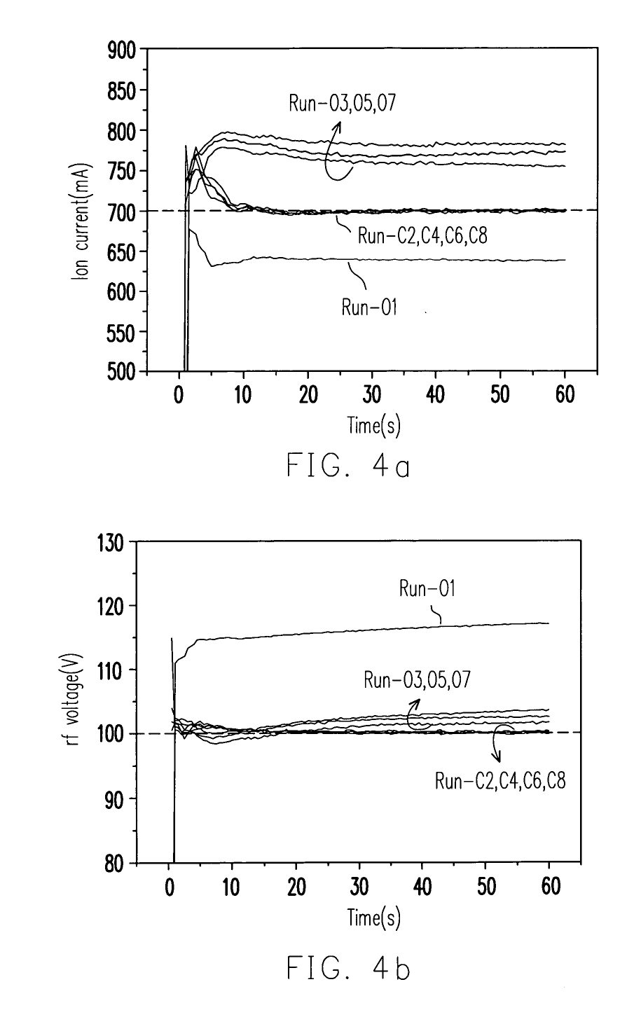

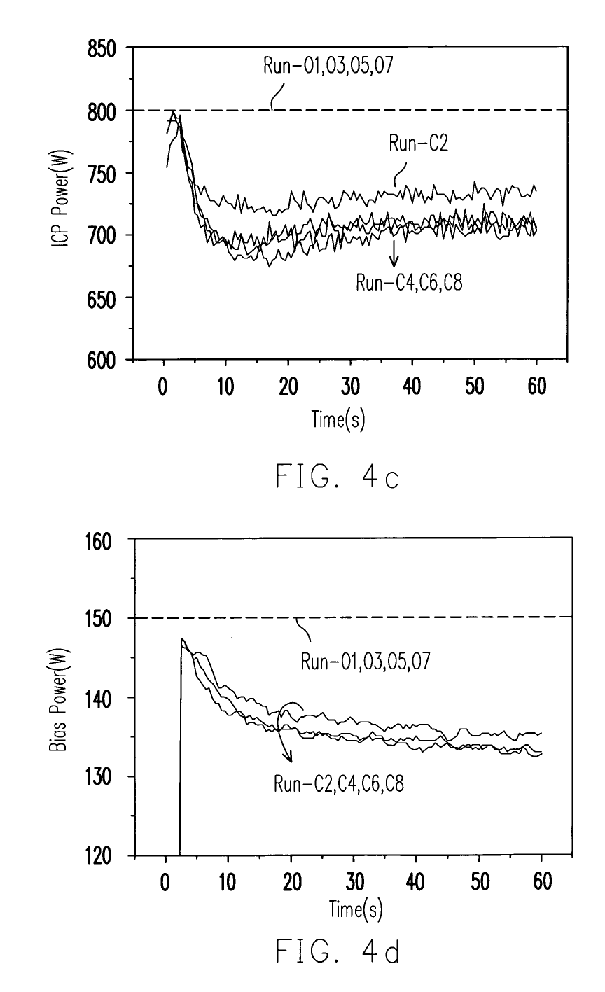

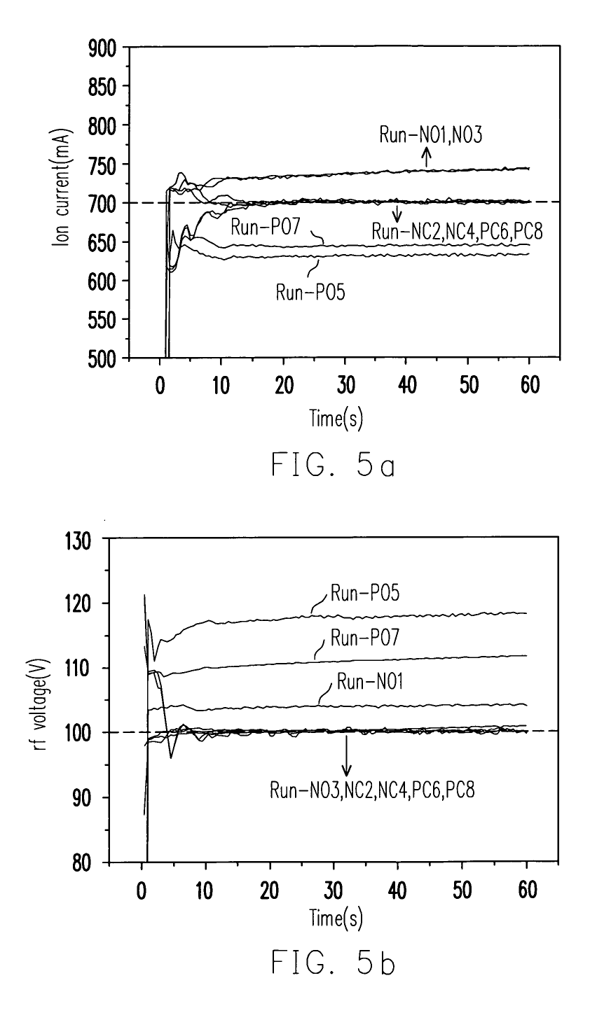

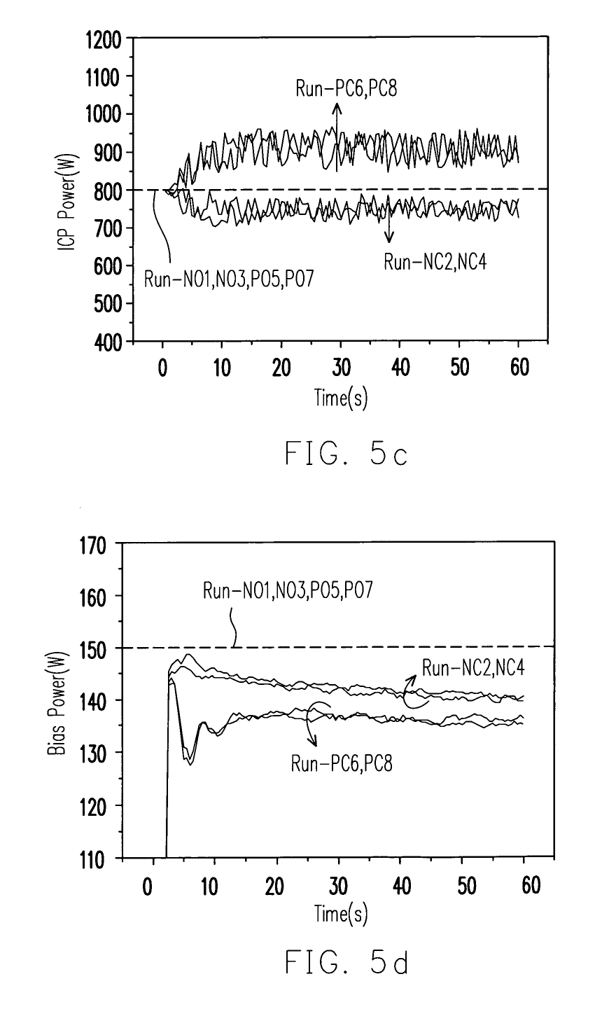

Please refer to FIGS. 3(a) and 3(b) showing the dynamic response of the close-loop and open-loop design control in fully operational state. The dashed line indicates the set point, and the set points in FIGS. 4(a) to 4(d) are 760 mA, 103V, 800 W and 150 W, respectively.

In the open-loop control under steady state, the ion current and the RF voltage are approximately 760 mA and 100V, respectively, and will increase slowly. While in the close-loop control, the ion current and the RF voltage will reach the desired value smoothly, which demonstrates that the present invention is proper. As shown in FIG. 4(b), since the desired voltage is larger than that of the open-loop control, the bias voltage power of the close-loop control is larger than that of the open-loop control. The etching rates of the open-loop control are 329.24, 330.56 and 330.93 nm/min, respectively; and the etching rates of the close-loop control is 327.37, 334.66, and 336.22 nm/min, respectively. The average etching rates of the open-loop control and the close-loop control are 330.24±0.88 nm/min and 332.75±4.72 nm/min, respectively. The variation and standard deviation meet the requirement of the poly-silicon etching apparatus for ULSI fabrication. Even there is no the plasma parameter feedback control, the etching rate variation can also be minimized.

In order to study the influence of the ion current, RF voltage and the interaction between them on the etching rate, the 2² factional design is performed. The results are as shown in Table 1. The factor level, i.e. the value of ion current and RF voltage, should be properly selected, because too small difference between the factor levels may not result in meaningful outcome variation and too large difference may lead to nonlinear effect. In the experiment, the variation of the predefined factor levels is small so as to avoid resulting in non-linear portion. The result shows that if the ion current increases by 200 mA, the etching rate will increase by 53.27 nm/min; and if the RF voltage increases by 20V, the etching rate will increase by 21.30 nm/min. The ion current and the RF voltage are the main parameters that affect the process.

For the effect due to the interaction of ion current and RF voltage, i.e. the X₁X₂ term shown in Table 1, the difference of etching rate is 7.65 nm/min and the 95% confidence interval of the precision is 10.01 nm/min. Since the effect of this part is not significant, it can be omitted in the following model. And, the calculation model is as Formula 7:

$$ER = {ER}_{ref} + 53.28 \times \frac{X 1 - X {1}_{ref}}{200} + 21.30 \times \frac{X 2 - X {2}_{ref}}{20} \qquad ( 7 )$$

ER: etching rate

ER_{ref}: etching rate for reference

X1: ion current

X1_{ref}: ion current for reference

X2: RF voltage

X2_{ref}: RF voltage for reference

And, the second experiment is to investigate the effect of reducing etching rate due to temporary condition of the walls of the reaction chamber by the close-loop control. In the reaction chamber of the open-loop control and close-loop control, the flowing rates of chlorine/argon are the same as the aforementioned experiment. The operational condition of the open-loop control is 800 W plasma power and 150 W bias voltage power; for the close-loop control system, the ion current is set as 700 mA and the RF bias voltage is set as 100V. These setting values have several percent difference with the standard ion current and RF bias voltage which are obtained in steady state under the operational condition of the open-loop control is 800 W plasma power and 150 W bias voltage power in the reaction chamber 110. With these settings, whether the control system can bring the system to the new set points with a smooth trajectory can be examined. Referring FIGS. 4(a) to 4(d) which show the dynamic response of the close-loop and open-loop design control in plasma temporary condition. Wherein, RunO1˜O7 are experimental data of the open-loop system; RunC2˜C8 are experimental data of the close-loop system; O is the open-loop system; and C is the close-loop system.

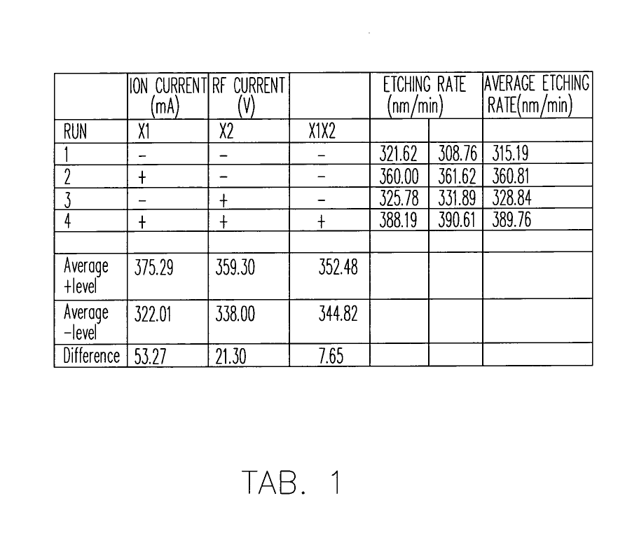

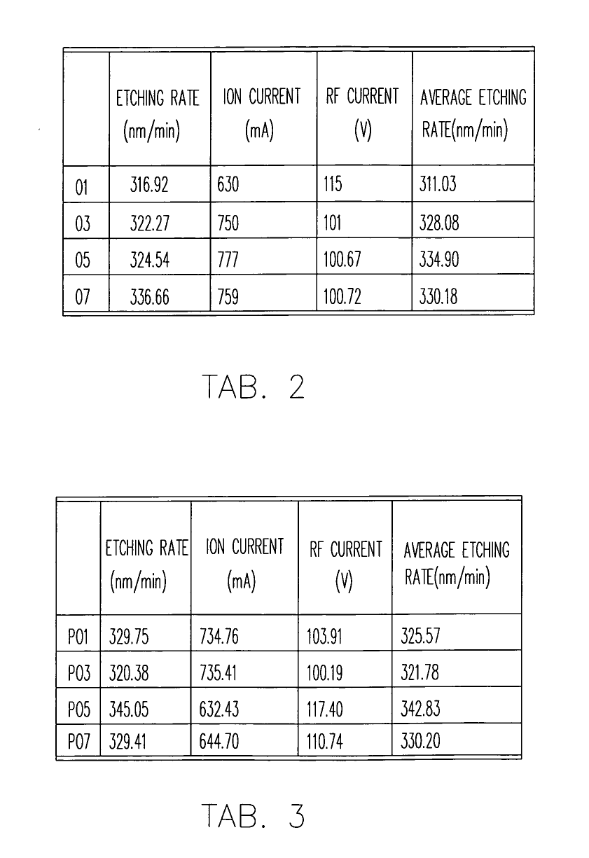

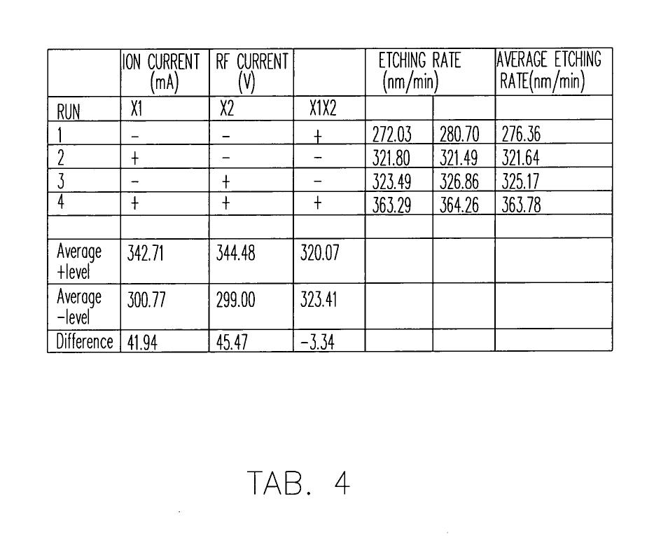

RunO1 is the first experiment of the day, compared with other open-loop control experiments, its lower ion current and the higher RF voltage indicate that the reaction chamber is in temporary condition. RunC2 is the second experiment of the day, and it is clear from the difference of the plasma power in FIG. 5(c) that: the plasma condition thereof is different with the plasma condition in other close-loop control (RunC4, RunC6, RunC8). Along with the continuous experiment, even there has slight difference between the measuring data of FIGS. 5(a) and 5(b), the power applied in FIGS. 5(c) and 5(d) are almost the same. The etching rate of RunC2, RunC4, RunC6, RunC8 is 312.67, 309.15, 313.80, 319.18 nm/min, respectively, and the average etching rate is 313.7±4.15 nm/min. Even the plasma power of Run2 is bigger, the etching rate is near to the etching rate obtained by other close-loop control. Therefore, the two items of ion current and RF bias voltage can indeed control the entire etching process, and the close-loop control is benefit for the entire process. We can learn from Tab. 1 that, as the etching rates due to the change of ion current and RF voltage are counteracted each other, the difference of etching rate is small.

The average etching rate by open-loop control is 327.82±7.74 nm/min. While in stable condition, the change of open-loop control is about two times of that of close-loop control. And, the last column in Tab. 2 is the estimating etching rate by Formula 7. For example, the etching rate of RunO1 is:

$$\begin{matrix}ER = 313.7 + 53.28 \times \frac{630 - 700}{200} + 21.30 \times \frac{115 - 100}{20} \\ = 311.03 ( nm \text{/} min )\end{matrix}$$

Wherein, 313.7 nm/min is the etching rate in the condition of 700 mA ion current and 100V RF voltage by close-loop control, and is set as the etching rate for reference. And, the result of Tab. 2 indicate: the model formula can estimate the etching rate correctly.

Next, we verify the effect of the feedback control overcoming the outside interference. Here, the change of the internal pressure in reaction chamber is considered as outside interfere. We import the interfere by changing the pressure from 10 mTorr to 12 mTorr in the etching process.

Please refer to FIG. 5(a) and FIG. 5(b) which show the dynamic response of the close-loop and open-loop design control with slight interference of pressure. Run NO1 and NO3 are the experiment data obtained in normal condition; Run PO5 and PO7 are the imported pressure interference; and all of Run NO1, NO3, Run PO5 and PO7 are open-loop experiments, wherein, N represents normal condition and P represents the condition with pressure interference. We can see the different values of ion current and RF voltage from the figure, and we can know from TAB. 3 that the etching rate has changed along the change of pressure, and the maximum change can up to 6%.

For close-loop control, Run NC2 and NC4 are the experiment value in normal condition, and Run PC6 and PC8 are the experiment value in condition with interference. It is known from FIG. 5(a), in the condition of 12 mTorr and 800 W plasma power, the ion current of Run PO5 and PO7 is smaller than 700 mA, therefore, the plasma power of Run PC6 and PC8 must be bigger than 800 W to have the ion current of Run PC6 and PC8 to reach 700 mA in the condition of 12 mTorr, and the plasma power is also bigger than the plasma power of Run NC2 and NC4 in condition of 10 mTorr. As shown in FIG. 5(b), the RF voltage of Run PO5 [symbol] PO7 is bigger than 100V at the condition of 12 mTorr.

And, TAB. 4 shows the result of the main effect items and the interaction thereof by the two items design with the 12 m Torr pressure. When the same number of change of ion current and RF voltage, the etching rate changed from 53.27 to 41.94 nm/min, and from 21.30 to 45.47 nm/min, respectively. The generated effect is much different with that at the condition with 10 mTorr, specially, the effect of the RF voltage is doubled. The estimating etching rate is shown in the fifth column in TAB. 3, and the quotiety of the model formula is from TAB. 4 and match the experiment value, so indicate that the experiment is correct. When using close-loop control, the etching rate is 311.77 [symbol] 312.52 nm/min in condition of 10 mTorr; and the etching rate is 319.55 and 315.26 nm/min in condition of 12 mTorr. Compared to the change of 6% by open-loop control, the maximum change by close-loop control is 2.4%. That is: the change due to the effect of the pressure change can be reduced by close-loop control. Although the change of the internal pressure in reaction chamber can affect the etching rate, it may not one suitable control variation. This is because that when changing the pressure of reaction chamber, the affect due to the pressure changing is much slow compared to other control variation.

In order to testify that the present invention can indeed to achieve the desired etching rate, we select the close-loop control etching process, wherein, the operation condition is 700 mA ion current and 100V RF voltage. The etching rate is 337.79 and 335.5 nm/min, and the average etching rate is 336.65 nm/min, so the average etching rate is just the etching rate for reference in model equation. However, the etching rate must reach 365 and 310 nm/min. According to Formula 7, we select 775 mA/108V and 625 mA/94V as setting value, and the final obtained etching rate is 361.77, 361.78 nm/min and 308.51, 300.98 nm/min, respectively. It verifies that we can achieve the desired etching rate by adjusting the expectation value of ion current and RF voltage.

In sum, the present invention utilizes the measured ion current and RF voltage as the control parameters of feedback control to adjust the output power of the plasma power generators and the RF bias voltage power generators, so that the plasma condition in the reaction chamber can be changed to achieve the desired etching rate.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An inductively-coupled plasma etch apparatus, including:
a reaction chamber;
an induction coil, configured within the reaction chamber, and a first bias voltage of the induction coil is provided via a plasma power generator;
an electrostatic chuck, disposed at the bottom of the reaction chamber, to support a wafer, and, the electrostatic chuck is connected to an RF bias voltage power generator, so to provide a second bias voltage of the electrostatic chuck, and, the reaction gas through the reaction chamber generates plasma via an electric field generated by the voltage difference between the first bias voltage and the second bias voltage, so as to etch the wafer;
a voltage/current measuring device, connected to the position between the electrostatic chuck and the RF bias voltage power generator, so as to measure an RF current, an RF voltage, and the phase angle between them on the electrostatic chuck and then obtain one ion current measured data and one RF voltage measured data; and
a controller, receiving the measured data of an RF bias voltage and of an ion current, and calculating the difference between the measured data and the predefined data of ion current, then creating a first control signal; and calculating the difference between the measured data and the predefined data of the RF bias voltage, then creating a second control signal; and the first and second control signals feedback control the plasma power generator and the RF bias voltage power generator, respectively.

2. The inductively-coupled plasma etch apparatus as claimed in claim 1, wherein the voltage/current measuring device is an RF ohmmeter.

3. The inductively-coupled plasma etch apparatus as claimed in claim 1, further includes a matching network configured between the induction coil and the plasma power generator.

4. The inductively-coupled plasma etch apparatus as claimed in claim 1, further includes a matching network configured between the voltage/current measuring device and the RF bias voltage power generator.

5. A feedback control method of a plasma etching process, applied to an inductively-coupled plasma etch apparatus, wherein, an induction coil and an electrostatic chuck supporting one wafer are disposed in the reaction chamber, and a bias voltage is applied to the induction coil and the electrostatic chuck by a plasma power generator and by an RF bias voltage power generator, respectively; and an electronic field is generated in the reaction chamber, so that reaction gas generates plasma to etch the wafer, which includes:
measuring the RF current, voltage and the phase angle between them on the electrostatic chuck in order to obtain one RF bias voltage measured data and one ion current measured data;
calculating the difference between the measured data and the predefined data of ion current, then creating a first control signal; and calculating the difference between the measured data and the predefined data of RF bias voltage, then creating a second control signal; and
the first and second control signals are used to feedback control the plasma power generator and RF bias voltage power generator, respectively.

6. A feedback control method of a plasma etching process applied to an inductively-coupled plasma etch apparatus; in the plasma etching process, the method controls the plasma status within the reaction chamber of inductively-coupled plasma etch apparatus by controlling the ion energy and ion density when the plasma impacts the surface of a wafer in a reaction chamber.

7. The feedback control method of a plasma etching process as claimed in claim 6, wherein the method of controlling the energy and density of the ion impacting the surface of the wafer is by measuring the RF current, voltage and the phase angle between them on the electrostatic chuck which supports the wafer, so to obtain the ion current and RF bias voltage measured data, and adjust the data to be nearer to the predefined RF bias voltage and the predefined ion current.

8. The feedback control method of a plasma etching process as claimed in claim 7, wherein the method of measuring the RF current, voltage and the phase angle between them is transmitting the signal related to the RF current, voltage and the phase via a transmission line with predefined length and resistance, and the signals are measured by a voltage/current measuring device.
